(19) United States
(12) Patent Application Publication
(10) Pub. No.: US 2019/0082182 A1
(43) Pub. Date: Mar. 14, 2019

(54) METHOD AND DEVICE FOR ENCODING DYNAMIC TEXTURES

(71) Applicants: UNIVERSITÉ DE NANTES, Nantes (FR); CENTRE NATIONAL DE LA RECHERCHE SCIENTIFIQUE, Paris (FR)

(72) Inventors: Karam NASER, Saint Herblain (FR); Vincent RICORDEL, Nort sur Erdre (FR); Patrick LE CALLET, Le Pallet (FR)

(21) Appl. No.: 15/699,957

(22) Filed: Sep. 8, 2017

(51) Int. Cl. H04N 19/147; H04N 19/149; G06T 7/49; H04N 19/176; H04N 19/98

(52) U.S. Cl. CPC H04N 19/147; H04N 19/149; H04N 19/98; H04N 19/176; G06T 7/49

(57) ABSTRACT

Some embodiments are directed to a method for encoding a dynamic texture region of a video sequence, said video sequence including a plurality of video frames and each video frame including at least one coding block. The method includes a rate-distortion optimization step in a coding loop based on a measured distortion value (SSD). According to the invention, the rate-distortion optimization includes the steps of estimating, for at least one current coding block of dynamic texture to be encoded, a perceived distortion value (SSDₚ), replacing the distortion value (SSD) measured for said current coding block of dynamic texture by said estimated perceived distortion value (SSDₚ), and applying the rate-distortion optimization step with said estimated perceived distortion value.

### BACKGROUND

The present invention relates generally to the field of video coding and video compression. More particularly it relates to a method and a related device for encoding dynamic textures.

The demand for high quality video services is continuously expanding. Modern technologies enable the end-user to record, view, stream and share videos with diverse qualities and resolutions. Due to the limited storage and transmission capacity, these videos are often compressed to match the available rate budget. This compression would necessarily degrade the quality and may introduced undesired decrease in the user quality of experience.

The state of the art video compression standard, known as HEVC (for High Efficiency Video Coding), has shown significant improvement over the previous one (AVC), in which it can provide up to 50% bitrate saving for the same subjective quality. This achievement is mainly due to better prediction mechanism as well as flexibility in the block partitioning.

Despite the high performance of HEVC, it shows weaknesses when it deals with dynamic textures. This prediction tools are not suited for these contents. It is especially true for inter prediction, in which high residual, after motion compensation, is to be encoded. In contrast, for ordinary signals, a small residual signal is yielded, and many blocks are skipped.

For this reason, coding dynamic textures represents a challenge. There has been lots of effort put to provide a better coding strategy. In particular, texture synthesis has been the prosperous alternative of the conventional coding. One of the first approaches was introduced by Patrick Ndjiki-Nya, Bela Makai, Gabi Blattermann, Aljoscha Smolic, Heiko Schwarz, and Thomas Wiegand in “Improved h. 264/AVC coding using texture analysis and synthesis” in Image Processing, 2003. ICIP 2003. Proceedings. 2003 International Conference on IEEE, 2003, vol. 3, pp. 111-849.

In this approach the textured areas are synthesized, and only the synthesis parameters are sent to the decoder. More recent approaches, such as in “An overview of texture and motion based video coding at purdue university” Marc Bosch, Fengqing Zhu, and Edward J Delp, in Picture Coding Symposium, 2009. PCS 2009. IEEE, 2009, pp. 1-4 and in “A parametric framework for video compression using region-based texture models”, Fan Zhang and David R Bull, Selected Topics in Signal Processing, IEEE Journal of, vol. 5, no. 7, pp. 1378-1392, 2011, are also following the same methodology.

The backbone of all of the synthesis based approaches is the quality of the synthesized textures. In which, a proper metric is needed to decide precisely whether to switch to synthesis or conventional coding. The metric is also desired to work on block level, which makes it difficult to be designed, and thus, it is still unsolved problem.

On the other hand, the coding efficiency can be improved by utilizing the knowledge about the human visual perception. A large body of research was put into developing several ways to compress the videos into the class of perceptual video compression, such as in “Perceptual visual signal compression and transmission”, Hong Ren Wu, Amy R Reibman, Weisi Lin, Fernando Pereira, and Sheila S Hemami, Proceedings of the IEEE, vol. 101, no. 9, pp. 2025-2043, 2013 and in, “Perceptual video compression: A survey”, Jong-Seok Lee and Touradj Ebrahimi, Selected Topics in Signal Processing, IEEE Journal of, vol. 6, no. 6, pp. 684-697, 2012.

An example of this is to consider the sensitivity of each region of the scene in distributing the bitrate. Most of these kind of approaches consider the static texture properties, whereas the dynamic texture are still not fully explored.

### SUMMARY

Some embodiments enhance or improve the encoding of dynamic textures for optimizing the bit rate for such regions. Current video compression standards (all MPEG-type standards up to and including HEVC) encode the texture information via hybrid schemes incorporating prediction steps and then transforming/quantifying/encoding steps for coding the prediction error. This coding scheme also incorporates a rate-distortion optimization step.

The rate-distortion optimization is a tool that is used inside the state of the art video encoder in order to achieve the best rate and distortion trade-off. For each encoder decision, the rate (expected number of bits) and distortion (expressed by a certain metric) is computed, and combined by a cost function. The cost value is then used to retain the best decision in terms of rate and distortion, which minimizes the computed cost.

Some embodiments minimize the cost function of dynamic textures in videos. The textures are widely present in the videos their details are perceptually less important than their semantic meaning. This property is exploited in the present invention.

Some embodiment proposes to integrate a perceptual distortion model within the coder in order to increase throughput while ensuring an equivalent perceptual quality of the decoded dynamic textures.

Some embodiments relate to a method for encoding a dynamic texture region of a video sequence, said video sequence including a plurality of video frames and each video frame including at least one coding block, said method including a rate-distortion optimization step in a coding loop based on a measured distortion value, wherein said rate-distortion optimization including the steps of:
estimating, for at least one current coding block of dynamic texture to be encoded, a perceived distortion value,
replacing the distortion value measured for said current coding block of dynamic texture by said estimated perceived distortion value, and
applying the rate-distortion optimization step with said estimated perceived distortion value.

Hence, the rate-distortion optimization during the encoding process is based on an estimated perceived distortion instead of a measured distortion. This method allows to reduce significantly the bit rate for some dynamic textures.

In some embodiments, the perceived distortion value is estimated from the measured distortion value by a predefined perceptual distortion model.

In some embodiments, the predefined perceptual distortion model includes at least one of piece-wise linear function.

In some embodiments, the predefined perceptual distortion model includes a plurality of piece-wise linear functions, each one of said plurality of piece-wise linear functions being allocated to a class of dynamic texture.

In some embodiments, the step for estimating the perceived distortion value for said current coding block includes:
determining a class of dynamic texture of said current coding block,
applying the piece-wise linear function allocated to said determined class, to the measured distortion value.

In some embodiments, the class of dynamic texture of said current coding block is determined by a learning machine approach.

Some embodiments also concern a device for encoding a dynamic texture region of a video sequence, said video sequence including a plurality of video frames and each video frame including at least one coding block, said device including at least one processor configured to implement a rate-distortion optimization step in a coding loop based on a measured distortion value, wherein the processor is configured to:
estimate, for at least one current coding block of dynamic texture to be encoded, a perceived distortion value,
replace the distortion value measured for said current coding block of dynamic texture by said estimated perceived distortion value, and
apply the rate-distortion optimization step with said estimated perceived distortion value.

Additional aspects of embodiments will be set forth, in part, in the detailed description, figures and any claims which follow, and in part will be derived from the detailed description. It is to be understood that both the foregoing general description and the following detailed description are only exemplary and do not limit the claimed embodiments.

### BRIEF DESCRIPTION OF THE DRAWINGS

Some embodiments of apparatus and/or methods will become more fully understood from the detailed description given herein below and the accompanying drawings which are given by way of illustration only and thus are not limiting of the present invention and wherein:

FIG. 1 is a flow chart illustrating the steps of the present invention;

FIG. 2 is a screen shot illustrating stimuli used for MLDS;

FIG. 3 shows 8 sequences used for implementing the perceptual distortion model; and

FIGS. 4 and 5 are two curves illustrating the difference between the perceived distortion and the measured distortion for two sequences of FIG. 3.

### DETAILED DESCRIPTION OF EXEMPLARY EMBODIMENTS

While example embodiments are capable of various modifications and alternative forms, embodiments thereof are shown by way of example in the drawings and will herein be described in details. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Before discussing example embodiments in more details, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks. Specific structural and functional details disclosed herein are merely representative for purposes of describing example embodiments. Some embodiments may, however, be embodied in many alternate forms and should not be construed as limited to only the embodiments set forth herein.

Some embodiments implemented in an encoder compliant with current video compression standards (MPEG-type standards up to and including HEVC) including a rate-distortion optimization step in a coding loop, said rate-distortion optimization step being based on a measured distortion value. According to the invention, the measured distortion value is replaced, in the rate-distortion optimization step, by an estimated perceived distortion value in order to save bit rate. This is due to the fact that, for dynamic textures, the perceived distortion is lower than or equal to the measured distortion.

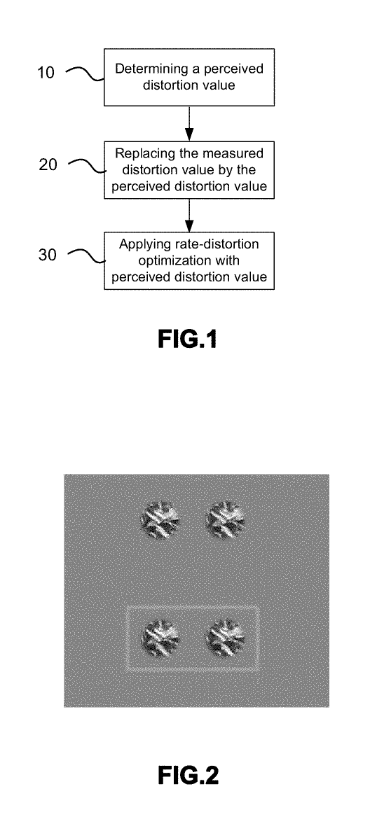

FIG. 1 is a flow chart showing the steps of the present invention. According to the invention, the rate-distortion optimization includes the following steps:
step 10: estimating, for at least one current coding block of dynamic texture to be encoded, a perceived distortion value,
step 20: replacing the distortion value measured for said current coding block of dynamic texture by the estimated perceived distortion value, and
step 30: applying the rate-distortion optimization step with said estimated perceived distortion value.

Each one of the steps 10 to 30 mentioned above is described in more detail hereinafter.

Sten 10

In step 10, the perceived distortion value is preferably estimated by using a perceptual distortion model. This perceptual distortion model may include one piece-wise linear function or a plurality of piece-wise linear functions allocating a perceived distortion value to each distortion value usually measured during the rate-distortion optimization of the video coding.

An example of perceptual distortion model is detailed below. This model is generated by using the methodology known as the Maximum Likelihood Difference Scaling or MLDS. It is based on comparing supra-threshold distortions by comparing two pairs of stimuli, and selecting the pair that shows a higher difference. The method has shown a good performance in the task of estimating the perceived distortions of compressed images in “MLDS: Maximum likelihood difference scaling in R”, Kenneth Knoblauch, Laurence T Maloney, et al., Journal of Statistical Software, vol. 25, no. 2, pp. 1-26, 2008. Adapting MLDS in this work is straightforward. The observers were presented 4 sequences that are horizontally 1 degree of visual angle apart, and 3 degrees vertically. An example of 4 sequences are shown in FIG. 2. The observers were asked to select the pair that shows more visual difference, as compared to the other pair. The selection was done via the keyboard arrows, and by pressing “enter” to validate the selection.

This subjective test was conducted in a professional room specifically designed for subjective testing. It complies with the ITU recommendations regarding the room lighting and screen brightness. The used screen was a TVLogic LVM401 with a resolution of 1920×1080 at 60 Hz. The viewing distance was 3H, where H is the screen height.

Since the present perceptual distortion model is to be used for video coding purpose and knowing that the video coding standards work on small blocks, with limited access to the past and future frames, the optimal model is the one that has a very short spatio-temporal extent. Two sequences issued from two dynamic texture datasets, namely DynTex dataset and BVI textures were used. 43 sequences were collected from these two collections. These sequences have 128×128 spatial extent (4 Coding Tree Units) and 500 ms temporal extent.

For the subjective evaluation, it is inconvenient to use all the 43 sequences, but rather a representative subset that covers the original feature space. This is to reduce the effort required to obtain the subjective results. The rate-distortion behavior of these sequences was considered as the distinguishing feature. Using HEVC reference software (HM 16.2), the sequences are encoded to 10 levels of Quantization Parameter (QP), and the Bjontegaard delta PSNR (BD-PSNR) is computed between all sequences. The sequence which has the minimum sum of BD-PSNR compared with all the other sequences is considered as the reference one, and the BD-PSNR with respect to this sequence is considered as the sequence feature. Accordingly, 8 sequences is retrieved using k-means clustering algorithm (k=8).

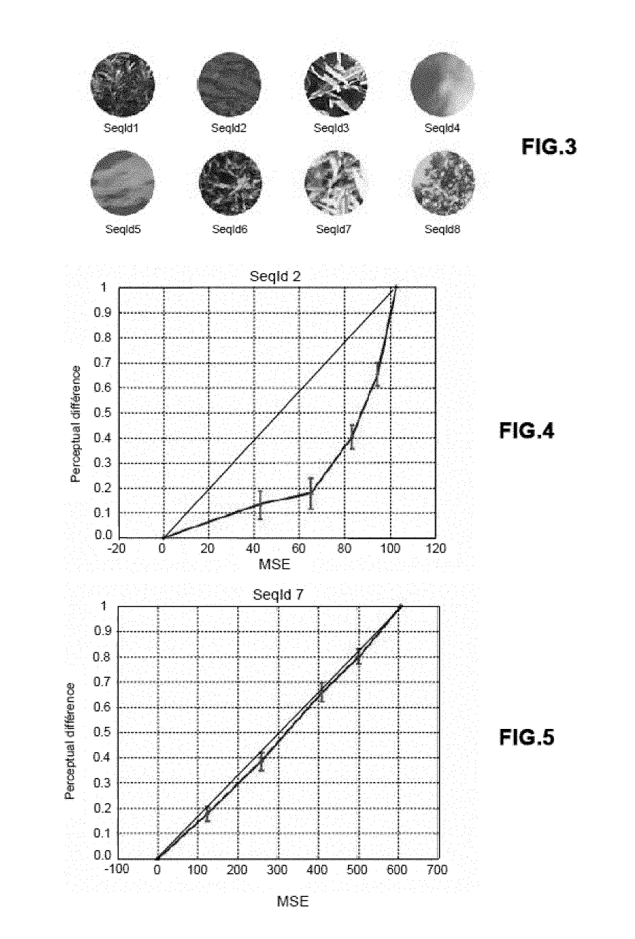

Finally, in the subjective test, only the inner circle of 91 pixels diameter are shown to the viewers. Upon the end of each sequence, it is repeated with time reversal in order to avoid temporal flickering artifacts. The 8 sequences are shown in FIG. 3. For clarity, each video is assigned to a SeqId from 1 to 8, which follows the same order as shown in the figure (from left to right, and top to bottom).

The binary response of the observers was converted to a perceptual difference scale as described in “Maximum likelihood difference scaling”, Laurence T Maloney and Joong Nam Yang, Journal of Vision, vol. 3, no. 8, pp. 5, 2003. It can be interpreted as effect of the change of a physical quantity on the perceived one. In the present case, this corresponds to the average MSE (Mean Square error) and perceived difference. Examples of the results are shown in FIGS. 4 and 5. The x-axes represents the overall average MSE of all the frames, whereas the y-axes represents the perceived difference. The confidence intervals are computing by learning the observers probability and repeat 10000 simulations using a boot-strapping procedure as explained in “MLDS: Maximum likelihood difference scaling in R”, Kenneth Knoblauch, Laurence T Maloney, et al., Journal of Statistical Software, vol. 25, no. 2, pp. 1-26, 2008.

The two curves shown in FIGS. 4 and 5 represent two different trends in the MSE versus perceptual difference relationship. The first trend, as for SeqId 2, shows that there is a big deviation between the measured distortion (MSE) and the perceived one. On the other hand, the second trend, which is shown for SeqId 7, indicates that MSE is directly proportional to the perceived value of distortion.

The perceptual distortion model may be defined as a set of piece-wise linear functions, for example a first one for the dynamic textures like SeqId 1, a second one for the dynamic textures like SeqId 2, a third one for the dynamic textures like SeqId 3, . . . . A same function may be allocated to a plurality of dynamic textures. Each piece-wise linear function allocates to each measured distortion in MSE a perceived distortion value MSEₚ such as MSEₚ=α·MSE+β for each piece of the function.

This model is content dependent, but it can be predicted based on feature analysis. This means that the piece-wise linear function to be used for a block to be encoded can be predicted based on a feature analysis of this block. For example, in a case of a perceptual distortion model based on the 8 sequences SeqId1 to SeqId8 to each of which a piece-wise linear functions is allocated, the prediction consists in determining the piece-wise linear function (among the 8 piece-wise linear functions) to be used for the current block to be encoded.

This prediction of the piece-wise linear function to be used can be defined by a machine learning approach. Such a method is described below. We use a set of few, computationally simple, features in the machine learning approach. First, we selected the spatial and temporal information (SI and TI) as described in “Subjective video quality assessment methods for multimedia applications” ITU-T RECOMMENDATION, 1999 and the colorfullness (CF) as described in “Analysis of public image and video databases for quality assessment” Stefan Winkler, Selected Topics in Signal Processing, IEEE Journal of, vol. 6, no. 6, pp. 616-625, 2012.

These features (TI, SI, CF) are often used to categorize contents in datasets. For image analysis, the gray-level co-occurrence matrix is one of the highly used features for different classification/recognition problems. However, we use only its homogeneity property. On the other side, we use also some dynamic texture features, namely the curl and peakness of normal flow as defined in “Dynamic texture recognition using normal flow and texture regularity” Renaud Peteri and Dmitry Chetverikov, Pattern Recognition and Image Analysis, pp. 223-230. Springer, 2005.

This set of features is used in the form of linear regression. The performance is evaluated by the mean squared error (normalized) of leave one out cross-validation test, which has a value of 0.087. This indicates that model prediction is reasonably well.

The trained linear regression model is used to predict the perceptual distortion model parameters of novel sequences. For this training, 43 dynamic texture sequences mentioned above are used. For 8 sequences (SeqId1 to SeqId8), the piece-wise linear function is already known. A class is allocated to each of these piece-wise linear functions (or to each of these 8 sequences). For the rest of sequences (35 sequences), the trained linear regression model is used to predict their perceptual distortion model and their class.

According to some embodiments, a same class may be allocated to a plurality of dynamic textures and a specific piece-wise linear function is allocated to each class.

Sten 20

In HEVC, the best prediction mode and block splitting are selected when they minimize the combined rate and distortion cost. The distortion is the Sum of Squared Differences (SSD), which is the MSE value multiplied by the number N of pixels belonging to the block to be encoded, and the combination of rate R and distortion D is done via a Lagrangian multiplier X in a cost function J as follows:

SSD=MSE×N and J=D+λ·R.

λ is the Lagrangian multiplier used for finding the minimum of the cost value J. The optimum value of λ corresponds to the negative derivative of distortion over rate.

A straightforward way to utilize the perceptual model in the video compression scenario (HEVC) is to replace the distortion measure SSD in HEVC by its perceived value SSDₚ:

SSDₚ=MSEₚ×N

SSDₚ=(α·MSE+β)×N

The parameters α and β are the parameters of the part of the piece-wise linear function associated to the measured distortion MSE.

A new lambda value λₚ can be also derived as follows:

$${λ}_{p} = - \frac{\partial {SSD}_{p}}{\partial R} = ( \frac{\partial {SSD}_{p}}{\partial SSD} ) \times ( - \frac{\partial SSD}{\partial R} ) = α \times λ$$

Thus the step may consist in replacing λ by λₚ.

Step 30

The step of applying the rate-distortion optimization step with a perceived distortion value consists in using the cost function Jₚ=D+λₚ·R in the coding loop of the encoding process.

The present rate-distortion optimization allows significant bitrate savings. The optimization process was used for the specific sequences, which showed a large deviation between the measured distortion (in terms of MSE) and perceived one. These sequences are the sequences SeqId1, SeqId2, SeqId3 and SeqId8 (FIG. 3). The sequences were encoded to three quality levels: high quality (quantization parameter Q1), middle quality (quantization parameter Q2) and low quality (quantization parameter Q3). The bitrate saving (%) at the same subjective quality is shown in Table I. +− refers to 95% confidence interval.

TABLE I

| | | | | Aver- |
|---|---|---|---|---|
| SeqId | Q1 | Q2 | Q3 | age(row) |
| 1 | 12.2 +− 7.4 | 6.8 +− 2.2 | 19.2 +− 1.4 | 12.7 +− 3.7 |
| 2 | 40.4 +− 1.3 | 34.9 +− 1.0 | 20.7 +− 0.9 | 32.0 +− 1.1 |
| 3 | 36.9 +− 4.6 | 37.3 +− 5.5 | 33.5 +− 6.02 | 35.9 +− 6.0 |
| 8 | 13.3 +− 5.9 | 26.9 +− 6.3 | 3.8 − 7.4 | 14.6 +− 6.5 |
| Average(col) | 25.7 +− 5.3 | 26.5 +− 3.7 | 19.3 +− 3.9 | 23.8 +− 4.3 |

One can clearly realize that the proposed perceptual optimization algorithm provides a significant bitrate saving, up to 37%.

The advantages of the proposed optimization method are the simplicity and compatibility. That is, no need for a complicated quality metric and only linear mapping of the used distortion measure is needed. In terms of compatibility, there is no change in the reference decoder, so the sequences can be directly decoded by the HEVC standard. The process is compatible with any standard MPEG-type video encoder.

Although some embodiments have been illustrated in the accompanying Drawings and described in the foregoing Detailed Description, it should be understood that these embodiments are not limited to the disclosed embodiments, but is capable of numerous rearrangements, modifications and substitutions without departing from the invention as set forth and defined by the following claims.

1. A method for encoding a dynamic texture region of a video sequence, the video sequence including a plurality of video frames and each video frame including at least one coding block, the method further including a rate-distortion optimization step in a coding loop based on a measured distortion value (SSD), the rate-distortion optimization comprising the steps of:
estimating, for at least one current coding block of dynamic texture to be encoded, a perceived distortion value (SSDₚ),
replacing the distortion value (SSD) measured for the current coding block of dynamic texture by the estimated perceived distortion value (SSDₚ), and
applying the rate-distortion optimization step with the estimated perceived distortion value.

2. The method according to claim 1, wherein the perceived distortion value is estimated from the measured distortion value by a predefined perceptual distortion model.

3. The method according to claim 2, wherein the predefined perceptual distortion model includes at least one of piece-wise linear function.

4. The method according to claim 3, wherein the predefined perceptual distortion model includes a plurality of piece-wise linear functions, each one of the plurality of piece-wise linear functions being allocated to a class of dynamic texture.

5. The method according to claim 4, wherein the step for estimating the perceived distortion value for the current coding block includes:
determining a class of dynamic texture of the current coding block, and
applying the piece-wise linear function allocated to said determined class, to the measured distortion value.

6. The method according to claim 5, wherein the class of dynamic texture of the current coding block is determined by a learning machine approach.

7. A device for encoding a dynamic texture region of a video sequence, the video sequence including a plurality of video frames and each video frame including at least one coding block, the device including at least one processor configured to implement a rate-distortion optimization step in a coding loop based on a measured distortion value (SSD), wherein the processor is configured to:
estimate, for at least one current coding block of dynamic texture to be encoded, a perceived distortion value (SSDₚ),
replace the distortion value (SSD) measured for the current coding block of dynamic texture by said estimated perceived distortion value (SSDₚ), and
apply the rate-distortion optimization step with said estimated perceived distortion value.
